(19) United States
(12) Patent Application Publication
(10) Pub. No.: US 2013/0260766 A1
(43) Pub. Date: Oct. 3, 2013

(54) Method for Recovering Connection Failure in Wireless Communication System and Device Therefor

(71) Applicants: Youngdae Lee, Gyeonggi-do (KR); Seungjune Yi, Gyeonggi-do (KR); Sungduck Chun, Gyeonggi-do (KR); Sungjun Park, Gyeonggi-do (KR); Sunghoon Jung, Gyeonggi-do (KR)

(72) Inventors: Youngdae Lee, Gyeonggi-do (KR); Seungjune Yi, Gyeonggi-do (KR); Sungduck Chun, Gyeonggi-do (KR); Sungjun Park, Gyeonggi-do (KR); Sunghoon Jung, Gyeonggi-do (KR)

(73) Assignee: LG Electronics Inc., Seoul (KR)

(21) Appl. No.: 13/991,945

(22) PCT Filed: Jan. 6, 2012
(86) PCT No.: PCT/KR2012/000187

§ 371 Date: Jun. 6, 2013

Related U.S. Application Data
(60) Provisional application No. 61/430,519, filed on Jan. 6, 2011.

(51) Int. Cl. H04W 76/02

(52) U.S. Cl. CPC H04W 76/028
USPC 455/436

(57) ABSTRACT

The present invention relates to a wireless communication system. In particular, the present invention relates to a method for a terminal to reset the connection in a wireless communication system and a device therefor, and comprises: a step for receiving information on a specific time interval while setting up the connection with a network; a step for detecting a connection failure or releasing the connection with the network; and a step for receiving one or more cell signals through the specific time interval, for cell, selection, after the detection or the release.

### FIELD OF THE INVENTION

The present invention relates to a wireless communication system and, more particularly, to a wireless communication system including heterogeneous cells.

### BACKGROUND ART

Wireless communication systems are evolving extensively in order to provide diverse types of communication services, such as audio and video data, and so on. Generally, a mobile communication system corresponds to a multiple access system that shares available system resource (e.g., bandwidth, transmission power, and so on) so as to be capable of supporting communication between multiple users. Examples of the multiple access system include a CDMA (code division multiple access) system, a FDMA (frequency division multiple access) system, a TDMA (time division multiple access) system, an OFDMA (orthogonal frequency division multiple access) system, an SC-FDMA (single carrier frequency division multiple access) system, and so on.

### DETAILED DESCRIPTION OF THE INVENTION

### Technical Objects

An object of the present invention is to provide a method for efficiently recovering connection in case of a connection failure in a wireless communication system and a device therefor. Another object of the present invention is to provide a method for efficiently performing connection reconfiguration and a device therefor. And, a further object of the present invention is to provide a method for efficiently performing cell selection/re-selection and a device therefor.

The technical objects of the present invention will not be limited only to the objects described above. Accordingly, additional technical objects of the present application will be set forth in part in the description which follows and in part will become apparent to those having ordinary skill in the art upon examination of the following or may be learned from practice of the present application.

### Technical Solutions

In an aspect of the present invention, provided herein is a method for reconfiguring a connection at a User Equipment (UE) in a wireless communication system, the method comprising the steps of receiving information about a specific time region in a state that a connection with a network is configured; detecting a connection failure or releasing the connection with the network; and receiving, for a cell selection, signals of one and more cells through the specific time region, after the detection or the release.

Preferably, the user equipment may select a specific cell of the one and more cells and may reconfigure a connection with the specific cell.

Preferably, the signals of the one and more cells are received by using previous information about the specific time region before updated information about the specific time region is received.

Preferably, the updated information is received through system information or dedicated signaling for the UE.

In another aspect of the present invention, provided herein is a User Equipment (UE) configured to reset a connection in a wireless communication system including a Radio Frequency (RF) unit; and a processor, wherein the processor is configured to receive information about a specific time region in a state that a connection with a network is configured, to detect a connection failure or release the connection with the network, and to receive, for a cell selection, signals of one and more cells through the specific time region, after the detection or the release.

### Effects of the Invention

According to the exemplary embodiments of the present invention, when a connection failure occurs in a wireless communication system, the connection may be efficiently recovered. Additionally, connection reconfiguration may be efficiently performed. Furthermore, cell selection/re-selection may be efficiently performed.

The effects that may be gained from the embodiment of the present invention will not be limited only to the effects described above. Accordingly, additional effects of the present application will be set forth in part in the description which follows and in part will become apparent to those having ordinary skill in the art upon examination of the following or may be learned from practice of the present application. More specifically, unintended effects obtained upon the practice of the present invention may also be derived by anyone having ordinary skill in the art.

### BRIEF DESCRIPTION OF THE DRAWINGS

The accompanying drawings, which are included to provide a further understanding of the invention and are incorporated in and constitute a part of this application, illustrate embodiments of the invention and along with the description serve to explain the technical spirit and scope (or principle) of the invention.

FIG. 1 illustrates an exemplary network structure of an E-UMTS.

FIG. 2 illustrates exemplary structures of an E-UTRAN and a gateway.

FIGS. 3A˜3B illustrate a user-plane protocol and a control-plane protocol stack for the E-UMTS.

FIG. 4 illustrates an exemplary structure of a downlink physical channel.

FIG. 5 illustrates an exemplary random access procedure for an E-UTRAN initial access.

FIG. 6 illustrates an exemplary handover procedure.

FIG. 7 illustrates an exemplary cell selection/re-selection procedure.

FIG. 8 illustrates an exemplary heterogeneous network including a macro cell and a micro cell.

FIG. 9 illustrates an exemplary related art ICIC scenario respective to a network configuration.

FIGS. 10A˜10B illustrate an exemplary case when a connection failure occurs.

FIGS. 11˜12 illustrate exemplary operations according to the exemplary embodiment of the present invention.

FIG. 13 illustrates an exemplary communication device (e.g., user equipment, base station) that is used in the exemplary communication system described in the present invention.

### BEST MODE FOR CARRYING OUT THE PRESENT INVENTION

The technology described below may be used in a wide range of wireless access systems, such as CDMA (Code Division Multiple Access), FDMA (Frequency Division Multiple Access), TDMA (Time Division Multiple Access), OFDMA (Orthogonal Frequency Division Multiple Access), SC-FDMA (Single Carrier Frequency Division Multiple Access), and so on. Herein, the CDMA may be realized by a radio technology such as UTRA (Universal Terrestrial Radio Access) or CDMA2000. The TDMA may be realized by a radio technology such as GSM (Global System for Mobile communications)/GPRS (General Packet Radio Service)/EDGE (Enhanced Data Rates for GSM Evolution). The OFDMA may be realized by a radio technology such as IEEE 802.11 (Wi-Fi), IEEE 802.16 (WiMAX), IEEE 802-20, E-UTRA (Evolved UTRA), and so on. The UTRA corresponds to a portion of the UMTS (Universal Mobile Telecommunications System). The UMTS corresponds to a 3^{rd} Generation (3G) asynchronous mobile communication system, which operates in European system-based Wideband Code Division Multiple Access (WCDMA), Global System for Mobile communication (GSM), and a General Packet Radio Service (GPRS). And, as a portion of the E-UMTS (Evolved UMTS) using the E-UTRA, the 3GPP (3rd Generation Partnership Project) LTE (long term evolution) system adopts the OFDMA in a downlink and adopts the SC-FDMA in an uplink. The LTE-A (LTE-Advanced) corresponds to an evolved version of the 3GPP LTE system.

For the clarity in the description of the present invention, the present invention will be described based upon the 3GPP LTE/LTE-A systems. Nevertheless, the scope and spirit of the present invention will not be limited only to those of the 3GPP LTE system and the 3GPP LTE-A system. Additionally, the specific terms used in the following description of the present invention are provided to facilitate the understanding of the present invention. And, therefore, without deviating from the technical scope and spirit of the present invention, such specific terms may also be varied and/or replaced by other terms.

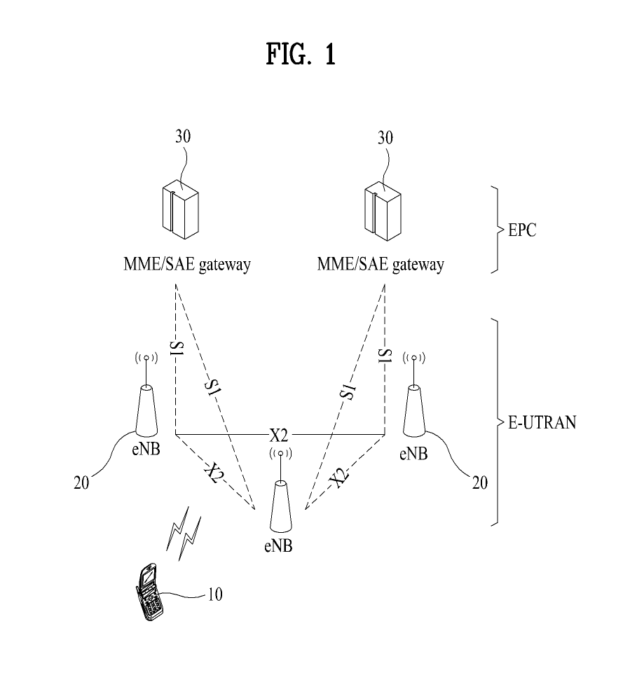

FIG. 1 illustrates a block view showing a network structure of an E-UMTS. The E-UMTS is also referred to as an LTE system. A communication network is extensively positioned so as to provide diverse services, such as voice, VoIP (Voice over IP) through an IMS (IP Multimedia Subsystem), and packet data.

As shown in FIG. 1, the E-UMTS network includes an evolved UMTS Terrestrial Radio Access Network (E-UTRAN) and an evolved packet core (EPC) and one or more user equipments (UEs). The E-UTRAN may include one or more node Bs (eNBs) (20), and the plurality of user equipments (UEs) (10) may be located (or positioned) in a single cell. One or more E-UTRAN Mobility Management Entity/System Architecture Evolution (MME/SAE) gateways (30) may be located at the end of the network, so as to be connected with an external network.

In the description of the present invention, “downlink” refers to a communication transmitted from an eNB (20) to a UE (10), and an “uplink” refers to a communication transmitted from a UE to an eNB. The UE (10) corresponds to a communication device (or equipment) that is carried by the user, which is also referred to as a mobile station (MS), a user terminal (UT), a subscriber station (SS), or a radio (or wireless) device.

The eNB (20) provides the UE (10) with end points of a User Plane and a Control Plane. The MME/SAE gateway (30) provides the UE (10) with an end point having functions of session and mobility management. The eNB (20) and the MME/SAE gateway (30) may be connected to one another through an S1 interface.

The eNB (20) generally corresponds to fixed station that communicates with the UE (10) and is also referred to as a base station (BS) or an access point. One eNB (20) may be positioned in each cell. An interface for transmitted user traffic or control traffic may be used between the eNBs (20).

The MME performs diverse functions including NAS signaling respective to the eNB 20, NAS signaling security, AS security control, inter CN node signaling for mobility between 3GPP access networks, idle mode UE reachability (including control and execution of paging re-transmission), tracking region list management (for idle mode and connected mode UEs), PDN GW and serving GW selection, MME selection for handover accompanying MME variation (or change), SGSN selection for handover to a 2G or 3G 3GPP access network, bearer management including roaming, authentication, and dedicated bearer set-up, support for transmitting PWS (including ETWS and CMAS) messages. An SAE gateway host provides diverse functions including Per-user based packet filtering (e.g., using K packet checking), Lawful Interception, UE IP address allocation, transmission port level packet marting in a downlink, UL and DL service level charging (or billing), gating and rate reinforcement, DL rate reinforcement based upon APN-AMBR.

For clarity in the description of the present invention, the MME/SAE gateway (30) will be simply referred to as “gateway”. However, the MME/SAE gateway (30) shall include both MME and SAE gateways.

Multiple nodes may be connected between the eNB (20) and the gateway (30) through an S1 interface. The eNBs (20) may access one another through an X2 interface, and neighboring eNBs may have a mesh network structure including the X2 interface.

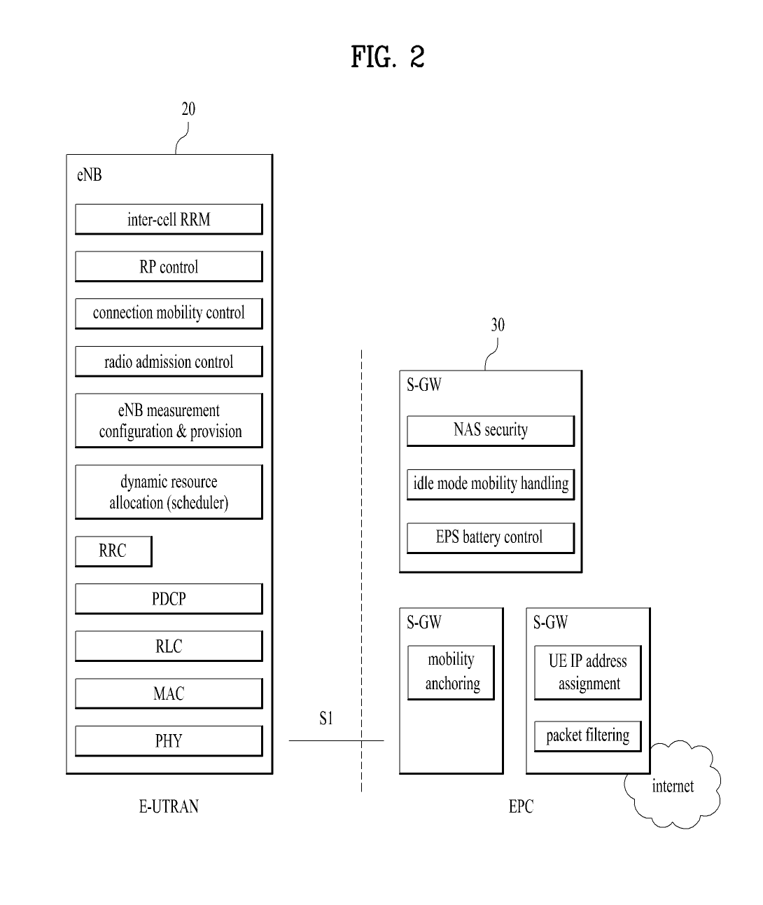

FIG. 2 illustrates a block view showing the structures of a general E-UTRAN and a general gateway (30). As shown in FIG. 2, the eNB (20) may perform the functions of selecting a gateway (30), routing to a gateway during Radio Resource Control (RRC) activation, scheduling and transmitting a paging message, scheduling and transmitting broadcast channel (BCCH) information, allocating dynamic resource for UEs (10) in both uplink and downlink, configuring and preparing for eNB measurement, controlling radio bearers, performing Radio Authorization Control (RAC), and performing connection mobility control in an LTE ACTIVE state. In the EPC, the gateway (30) may perform functions, such as paging transmission, LTE_IDLE state management, user plane encryption, System Architecture Evolution (SAE) bearer control, encryption of Non-Access Stratum (NAS) signaling, and integrity protection.

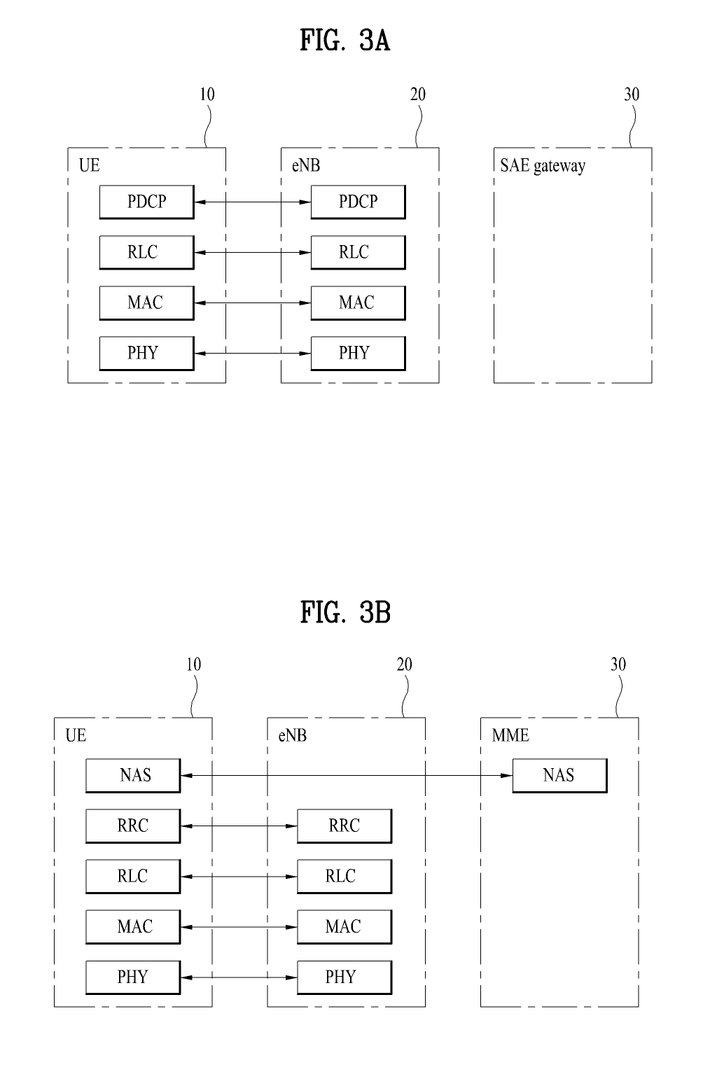

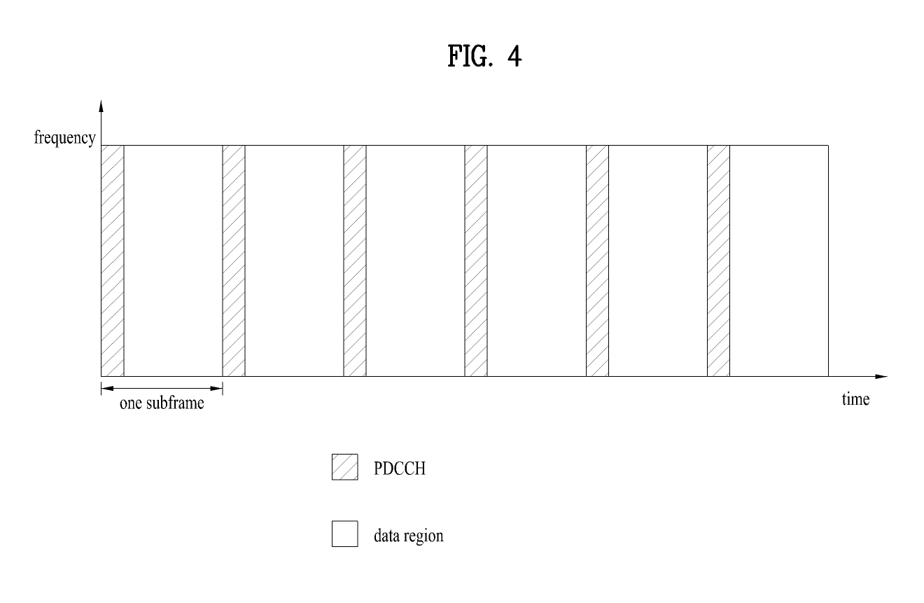

FIGS. 3A˜3B illustrate block views respectively showing a user-plane protocol and a control-plane protocol stack for the E-UMTS. As shown in FIGS. 3A and 3B, the protocol layers may be categorized as a first layer (L1), a second layer (L2), and a third layer (L3), based upon the three (3) lower layers of an open system interconnection (OSI) standard model, which is disclosed in the technical field of communication systems.

A physical layer, i.e., the first layer (L1) uses a physical channel, so as to provide an information transfer service to an upper (or higher) layer. The physical layer is connected to a medium access control (MAC) layer, which is located in a layer higher than the physical layer, through a transport channel, and data are transferred between the medium access control layer and the physical layer via the transport channel. Herein, data are transferred between one physical layer of a transmitting end and the other physical layer of a receiving end via the physical channel.

A MAC layer of the second layer (L2) provides a service to a radio link control (RLC) layer above the MAC layer via a logical channel. The RLC layer of the second layer (L2) supports reliable data transfer. In case the MAC layer performs the function of an RLC layer, the RLC layer may be included as a functional block of the MAC layer. Although the RLC layer is shown in FIGS. 3A and 3B, it should be noted that, in case the MAC layer performs the RLC function, the RLC layer is not required.

A PDCP layer of the second layer (L2) performs a header compression function, which decreases unnecessary control information. Herein, the header compression function is performed to efficiently transmit data, which use internet protocol (IP) packets such as IPv4 or IPv6, through a radio interface having a relatively narrow bandwidth.

A radio resource control (RRC) layer located on a lowest part of a third layer (L3) is defined in the control plane only. The RRC layer controls a logical channel, a transport channel, and a physical channel in association with configuration, re-configuration and release of radio bearers (RBs). Herein, RB refers to a service provided by the second layer (L2) for a data transfer between the UE (10) and the E-UTRAN.

As shown in FIG. 3A, the RLC and MAC layer are terminated in the eNB (20) of the network and may perform functions, such as scheduling, Automatic Re-transmission request (ARQ), and Hybrid Automatic Re-transmission request (HARQ). The PDCP layer is terminated in the eNB (20) of the network and may perform user-plane functions, such as header compression, integrity protection, and encryption.

As shown in FIG. 3B, the RLC and MAC layer are terminated in the eNB (20) of the network and may perform the same functions as those of the control plane. As shown in FIG. 3B, the RRC layer is terminated in the eNB (20) of the network and may perform functions, such as broadcasting, paging, RRC connection management, Radio Bearer (RB) control, mobility function, and UE (10) measurement report and control. As shown in FIG. 3B, a NAS control protocol is terminated in the MME of the gateway (30) of the network and may perform functions, such as SAE bearer management, authentication, LTE_IDLE mobility handling, LTE_IDLE paging transmission, and security control on the signaling between the gateway and the UE (10).

The RRC state may be divided into 2 different states, such as RRC_IDLE and RRC_CONNECTED.

In the RRC_IDLE state, the UE (10) may receive broadcasting of system information and paging information during a discontinuous reception (DRX), which is configured by a NAS, and the UE may be assigned (or allocated) with an ID, which can uniquely identify the UE in a tracking area, and may also perform PLMN (Public Land Mobile Network) selection and re-selection. Furthermore, in the RRC_IDLE state, no RRC context is stored in the eNB.

In the RRC_CONNECTED state, the UE (10) has a E-UTRAN RRC connection and context from the E-UTRAN and is capable of transmitting and/or receiving data to/from the eNB based upon the same. Additionally, the UE (10) may report channel quality information and feedback information to the eNB.

In the RRC_CONNECTED state, the E-UTRAN recognizes the cell to which the UE (10) belongs. Accordingly, the network may transmit and/or receive data to/from the UE (10), may control the mobility of the UE (e.g., handover, Inter-RAT (Inter-Radio Access Technology) cell change order to a GERAN (GSM EDGE Radio Access Network) having NACC (Net-work Assisted Cell Change), and may perform cell measurement of neighboring cells.

In the RRC_IDLE mode, the UE (10) specifies a paging DRX (discontinuous reception) cycle. More specifically, the UE (10) monitors a paging signal at a specific paging occasion for each UE-specific paging DRX cycle.

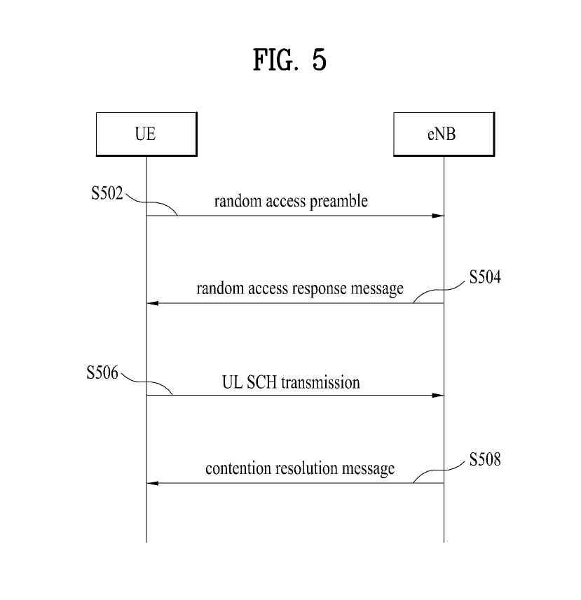

FIG. 4 illustrates an exemplary structure of a downlink physical channel, which is used in the E-UMTS system. A physical channel is configured of multiple sub-frames existing within a time axis and multiple sub-carriers existing within a frequency axis. Herein, one sun-frame is configured of a plurality of Symbols within the time axis. One sub-frame is configured of multiple Resource Blocks, and one resource block is configured of multiple symbols and multiple sub-carriers. Additionally, each sub-frame may use specific sub-carriers of specific symbols (e.g., first symbol) of a corresponding sub-frame for a PDCCH (Physical Downlink Control Channel), i.e., L1/L2 control channel. In FIG. 4, an L1/L2 control channel transport (or transmission) area (hatched portion) and a data transport (or transmission) area (non-hatched portion) are shown. In the E-UMTS (Evolved Universal Mobile Telecommunications System) system, which is still currently under discussion, a radio frame of 10 ms is used, and one radio frame is configured of 10 sub-frames. Additionally, one sub-frame is configured of two consecutive slots. The length of one slot is equal to 0.5 ms. Furthermore, one sub-frame is configured of multiple OFDM symbols, and, among the multiple OFDM symbols, some symbols (e.g., first symbol) may be used for transmitting the L1/L2 control information.

FIG. 5 illustrates an exemplary random access procedure for an E-UTRAN initial access.

A random access procedure is used for transmitting short-length data via uplink. For example, the random access procedure is performed during an initial access in the RRC_IDLE state, during an initial access after a radio link failure, during a handover requesting the random access procedure, and when uplink/downlink data requiring the random access procedure are generated while in the RRC_CONNECTED state. Some RRC messages, such as an RRC Connection Request Message, a Cell Update Message, and a URA Update Message, are also transmitted by using the random access procedure. A Logical channel CCCH (Common Control Channel), a DCCH (Dedicated Control Channel), a DTCH (Dedicated Traffic Channel) may be mapped to a transport channel RACH. The transport channel RACH is mapped to a physical channel PRACH (Physical Random Access Channel). When the MAC layer of the user equipment directs a PRACH transmission to the user equipment physical layer, the user equipment physical layer first selects an access slot and a signature, thereby transmitting a PRACH preamble via uplink. The random access procedure is divided into a contention based procedure and a non-contention based procedure.

Referring to FIG. 5, the user equipment receives and stores information about the random access from the base station through the system information. Thereafter, when random access is required, the user equipment transmits a Random Access Preamble (also referred to as Message 1) to the base station (S502). When the base station received the random access preamble from the user equipment, the base station transmits a Random Access Response message (also referred to as Message 2) to the user equipment (S504). More specifically, downlink scheduling information respective to the random access response message may be CRC-masked by using RA-RNTI (Random Access-RNTI), thereby being transmitted over the L1/L2 control channel (PDCCH). After receiving the downlink scheduling signal, which is masked by using the RA-RNTI, the user equipment may receive a random access response message from a PDSCH (Physical Downlink Shared Channel) and may then decode the received message. Thereafter, the user equipment verifies whether or not random access response information directed (or designated) to the user equipment itself exists in the random access response message. Information on whether or not random access response information directed (or designated) to the user equipment itself exists may be verified by information on whether or not an RAID (Random Access preamble ID) exists in the preamble, which is transmitted by the user equipment. The random access response information includes Timing Advance (TA) indicating timing offset information for synchronization, radio resource allocation information being used for the uplink, a temporary identifier (e.g., T-CRNTI) for user equipment identification, and so on. When the user equipment receives the random access response information, the user equipment transmits an uplink message (also referred to as Message 3) to an uplink SCH (Shared Channel) in accordance with the radio resource allocation information included in the response information (S506). After receiving the uplink message from the user equipment, the base station transmits a contention resolution (also referred to as Message 4) message to the user equipment (S508).

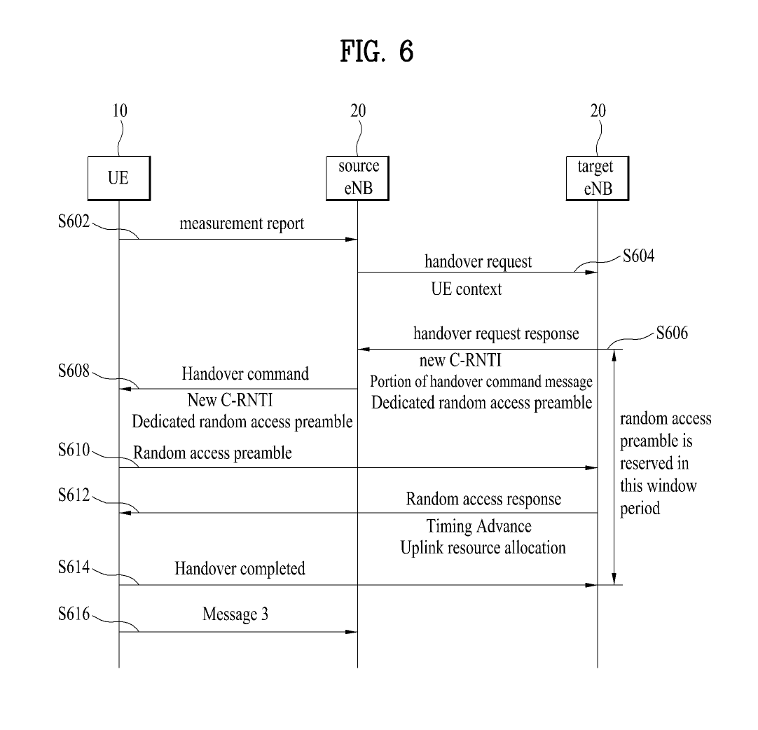

FIG. 6 illustrates an exemplary handover procedure. The UE (10) transmits a measurement report to a source eNB (20) (S602). The source eNB (20) transmits a handover request message to a target eNB along with UE (10) context (S604).

The target eNB (20) transmits a handover request response to the source eNB (S606). The handover request response includes a new C-RNTI, a portion of a handover command message, and information about random access, such as UE (10)-specific dedicated access signature for performing a contention-free random access in a target cell. The signature is reserved at this point.

The source eNB (20) transmits a handover command to the UE (S608). The handover command includes a new C-RNTI and information about random access, such as a dedicated signature for the UE (10) to use. The handover command may be directed by the transmission of an RRC connection reconfiguration message having MCI (Mobility Control Information).

The random access procedure is performed by the UE (10) in a target cell, after the handover command, so that the UE (10) can gain a Timing Advance (TA) value. Such random access procedure corresponds to a contention-free method, wherein a signature is reserved to the UE (10) in order to avoid contention.

By transmitting a random access preamble using the dedicated signature, the UE (10) initiates the random access procedure from the target eNB (20) (S610). The target eNB (20) transmits a random access response message to the UE (10) (S612). The random access response message includes a TA and uplink resource allocation. The UE (10) transmits a handover completion message to the target eNB (20) (S614).

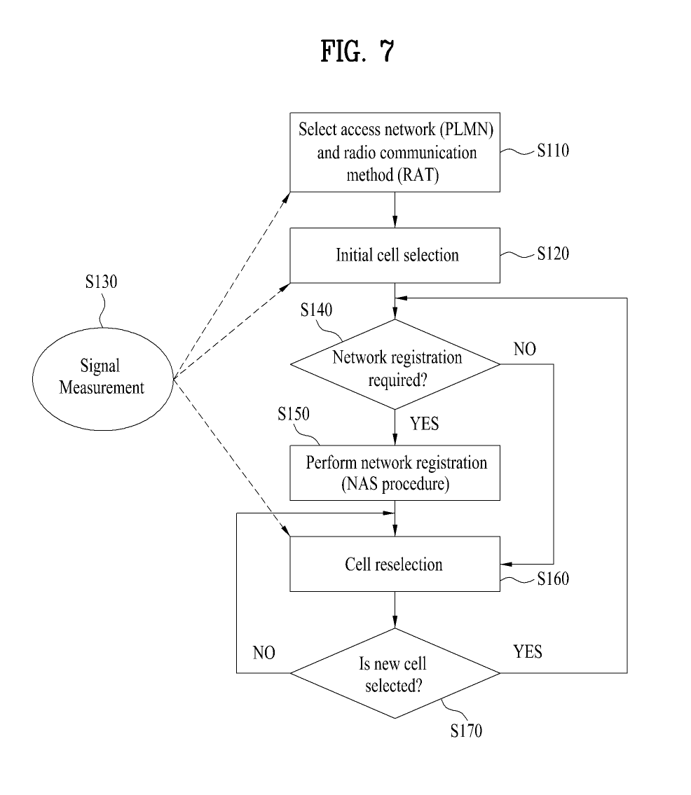

FIG. 7 illustrates an exemplary cell selection/re-selection procedure. A cell is selected for the purpose of being registered to a network in order to be provided with service from the base station. Herein, if intensity or quality of the signal between the user equipment and the base station is weakened or degraded due to the mobility of the user equipment, the user equipment re-selects another cell for the purpose of maintaining the transmission quality of the data.

Referring to FIG. 7, when the power is turned on, the user equipment automatically or manually selects a PLMN (Public Land Mobile Network), which corresponds to the network through which the user equipment seeks to be provided with service, and a Radio Access Technology (RAT) in order to perform communication (S110). The PLMN and RAT information may be selected by the user of the user equipment, or information pre-stored in a Universal Subscriber Identity Module (USIM) may be used. Thereafter, the user equipment performs an Initial Cell Selection procedure, wherein, among cells having signal intensity or quality values, which are measured between the user equipment and the base station, greater than a reference value, the user equipment selects a cell having the greatest value (S120). Herein, the reference value refers to a value that is defined within the system in order to ensure the quality of a physical signal during data transmission/reception. Therefore, the reference value may vary depending upon the applied RAT.

Subsequently, the user equipment received System Information (SI) that is periodically transmitted from the base station. The system information includes basic and essential information for the user equipment to access the network. Additionally, the system information may include information related to cells neighboring the serving cell (Neighbor Cell List, NCL). Accordingly, prior to accessing the base station, the user equipment should receive all system information and should be provided with the most recent system information. When the initial power is turned on, the user equipment selects a cell for receiving the system information in the idle mode.

The method for selecting a cell in the 3GPP UMTS and the procedure of the same will hereinafter be described in detail. When the power of the user equipment is first turned on, the user equipment selects a PLMN and RAT for radio (or wireless) communication, and, then, during the initial cell selection procedure corresponding S120 of FIG. 7, among neighboring cells having a signal that satisfies a predetermined condition (or requirement) through a signal measurement procedure with the base station within all searchable frequency bands, the user equipment selects a cell having the most intense (or greatest) signal characteristic value and accesses the selected cell.

The user equipment selects a cell having a measured signal intensity and quality that is greater than a specific value defined by the system. Thereafter, the user equipment requests for a call (e.g., Originating Call) to the network or stands-by in the idle mode in order to receive a service (e.g., Terminating Call) from the network. Subsequently, the user equipment registers its information, such as IMSI (International Mobile Subscriber Identity), in order to receive a service (e.g., Paging) from the network (S150). Although the idle mode user equipment is in a state of being capable of receiving control information, such as system information, from the cell, the idle mode user equipment is not is an RRC connected state with the UTRAN. Therefore, since the network is in a state of not being capable of knowing any exact (or accurate) information on the user equipment, the network uses IMSI, which is used in NAS (Non-Access Stratum). The user equipment does not register itself to the network each time the user equipment selects a cell, and the user equipment registers itself to the network in case the network information (e.g., Tracking Area Identity, TAI), which is included in the system information, is different from the network information known by the corresponding user equipment.

When the signal intensity or quality value measured from the base station providing service to the user equipment is smaller (or lower) than the value measured from the base station of a neighboring cell, the user equipment selects any one of the other neighboring cells providing a more enhanced signal characteristic than the cell of the base station which the corresponding user equipment is accessing (S160). In order to be differentiated from the Initial Cell Selection of step 5120, this procedure will be referred to as Cell Re-Selection. The idle mode user equipment repeats the procedure of reselecting a cell having a better signal characteristic by performing signal measurement of neighboring cells adjacent to the cell currently providing service to the user equipment. In order to prevent cells from being re-selected too frequently in accordance with the change in the signal characteristics, time limit (or temporal limitation) condition will be applied. Alternatively, if the signal characteristic value of the serving cell is greater than the predetermined reference value, since the user equipment is not required to perform cell re-selection, the user equipment may not perform measurement.

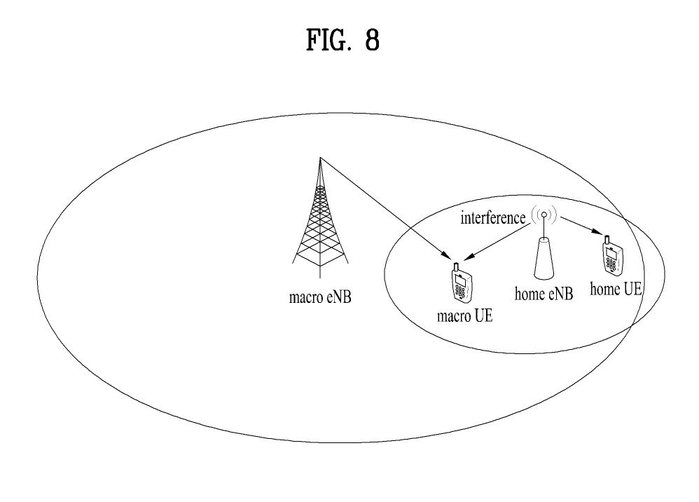

FIG. 8 illustrates an exemplary heterogeneous network including a macro cell and a micro cell. In a next generation communication standard including 3GPP LTE-A, a heterogeneous network having a micro cell a low-power transmission power overlapping a conventional macro cell coverage is currently being under discussion.

Referring to FIG. 8, the macro cell may overlap with one or more micro cells. The service of a macro cell is provided from a base station (Macro eNodeB, MeNB). In the description of the present invention, the macro cell and the macro base station may be used in combination. A user equipment that is accessing (or connected to) a macro cell may be referred to as a Macro user equipment (Macro UE, MUE). The macro user equipment receives signals from the macro base station and transmits signals to the macro base station.

A micro cell is also referred to as a femto cell or a pico cell. The service of a micro cell is provided (or serviced) by a pico base station (Pico eNodeB), a femto base station (Femto eNodeB), a home base station (Home eNodeB, HeNB), a Relay Node (RN), and so on. For simplicity, the drawing shows an example of a Home base station (HeNB) existing within the macro cell. In the description of the present invention, unless differentiated (or specified) otherwise, micro base station, pico base station, pico cell, femto base station, femto cell, home base station, home cell, relay node, relay cell may be used in combination. A user equipment accessing the micro cell may be referred to as a micro user equipment, a pico user equipment (Pico UE, PUE), a femto user equipment (Femto UE, FUE), a home user equipment (Home-UE, HUE), and so on. The micro user equipment receives signals from a micro base station (e.g., femto base station, pico base station) and transmits signals to the micro base station.

Depending upon its reachability, the micro cell may be divided into an OA (open access) cell and a CSG (closed subscriber group) cell. The OA cell refers to a micro cell from which a user equipment can receive service whenever required without any separate access limitation. On the other hand, a CSG cell refers to a micro cell from which only authorized specific user equipments can receive service. For example, the access to a CSG cell may be authorized only to specific user equipments that are authorized by membership.

In the heterogeneous network, since the macro cell is overlapped by the micro cell, inter-cell interference becomes a greater problem. As shown in FIG. 8, when the macro user equipment is located at a boundary of the macro cell and the micro cell, a downlink signal of a micro base station acts as interference to the macro user equipment. Similarly, a downlink signal of a macro base station may act as interference to a micro user equipment within the micro cell. Additionally, an uplink signal of the macro user equipment may act as interference to the micro base station. Similarly, an uplink signal of the micro user equipment may act as interference to the macro base station.

In case of a macro cell-micro cell heterogeneous network, the macro cell may generate intense interference to the user equipment of a micro cell and, most particularly, to a micro user equipment located at the boundary of the micro cell. Therefore, a method for resolving uplink and downlink interference respective to data and L1/L2 control signals, sync signals, and reference signals is required. An Inter-Cell Interference Cancellation (ICIC) method may be handled (or carried out) in time, frequency, and/or spatial domains.

Hereinafter, ICIC will be described in more detail. For simplicity, in case of macro cell-micro cell overlapping, it will be assumed that the target that is to be protected from inter-cell interference correspond to the pico user equipment. In this case, the network node generating interference becomes the macro cell (or macro base station).

In order to resolve inter-cell interference, a macro cell that generates inter-cell interference may configure an ABS (Almost Blank Subframe) within a radio frame. With the exception for a specific DL signal, the ABS indicates a subframe that is set-up so that general DL signals cannot be transmitted thereto. Although the specific DL signal is not limited only to the example given herein, the specific DL signal includes, for example, a CRS (Cell-specific Reference Signal or Cell-common Reference Signal). The ABS may be repeated so as to have a consistent pattern within one or more radio frames. Although the present invention will not be limited only to this, the macro cell may notify the micro cell of an ABS configuration (e.g., ABS allocation pattern) via backhaul, and the micro cell may schedule a micro user equipment by using the ABS configuration. For example, the micro user equipment may be scheduled only during the ABS section (or region). Additionally, CSI (Channel State Information) of the micro user equipment may be realized only in the ABS. The ABS allocation pattern may be directed by using bitmap, and, in this case, each bit indicates whether or not the respective subframe corresponds to the ABS. A cell list to which the ABS is applied may be signaled along with the ABS configuration.

As described above, when an interfered user equipment is configured to perform measurement for RLM (Radio Link Management)/RRM (Radio Resource Management) only in a limited subframe (e.g., ABS), unnecessary RLF (Radio Link Failure) may be prevented, and a measurement result of RSRQ (Reference Signal Received Quality)/RSRP (Reference Signal Received Power) may be accurately performed.

Additionally, when the user equipment measures the signal of an interfered cell in the ABS, a considerable number of signals of an interfering cell may be removed, so that the coverage of the interfered cell can be extended. This is referred to as a CRE (Cell Range Expansion).

An ICIC scenario may vary in accordance with a network configuration (e.g., reachability of the micro cell). For example, the ICIC scenario may vary depending upon the case of a macro cell-OA cell configuration and the case of a macro cell-CSG cell configuration. In case of the OA cell, since the reach (or approach) of any user equipment within the macro cell is authorized, handover may freely occur between the macro cell and the OA cell, and the network may move (or relocate) the macro user equipment to the OA cell for the purpose of load-distribution, and so on. Therefore, in case of the macro cell-OA cell, it is preferable to assign a higher priority to the protection and reachability to the OA cell. In order to do so, an ABS is determined in the macro cell, and the user equipment may use the ABS of the macro cell so as to measure the signal of the OA cell. As a result, the coverage of the OA cell is increased within the macro cell.

Conversely, in case of the CSG cell, the access of only specific user equipments is authorized and the access of other general user equipments within the macro cell is not authorized. Thus, when the protection of the CSG cell is prioritized, a large number of user equipments are sacrificed for a small number of specific user equipments. Therefore, in case of the Macro cell-CSG cell, and ABS is determined in the CSG cell, and the user equipment measures the signal of the macro cell by using the ABS of the CSG cell. Eventually, the coverage of the CSG cell within the macro cell is reduced.

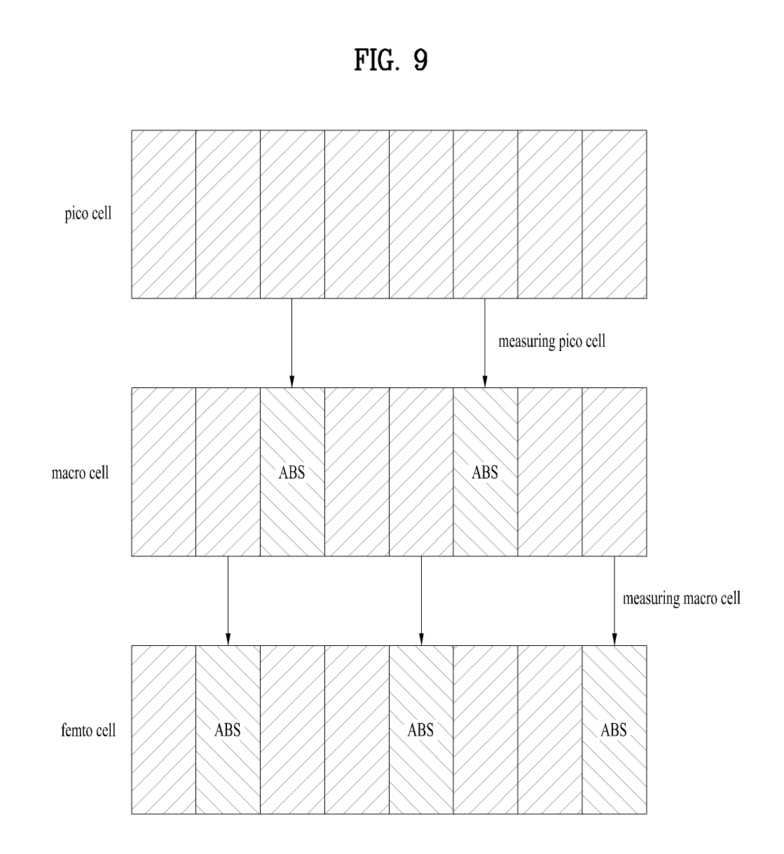

FIG. 9 illustrates an exemplary related art ICIC scenario respective to a network configuration. In the 3GPP, a pico cell is generally used as the OA cell, and the femto cell is used as the CSG cell. Hereinafter, unless specifically mentioned otherwise, it will be assumed that pico cell is used in combination with OA cell and that femto cell is used in combination with CSG cell.

Referring to FIG. 9, depending upon the network configuration the following operations may be performed.

In case of Macro cell-Pico cell (or OA cell):

a) A UE (Pico UE, PUE) receiving service from the pico cell may measure a signal of a serving pico cell by using an ABS of the macro cell. As a result, in light of the PUE, the coverage of the pico cell is extended (or expanded) (Pico CRE).

b) In order to fully (or sufficiently) and accurately measure a pico cell receiving interference from a signal of the macro cell (i.e., in order to allow in-bound movement (or repositioning) to a pico cell having a weak signal), the UE (Macro UE, MUE) receiving service from the macro cell may measure the signal of a neighboring pico cell by using the ABS of the macro cell. As a result, in light of the MUE, the coverage of the pico cell is extended (or expanded) (Pico CRE).

In case of Macro cell-Femto cell (or CSG cell):

c) In order to continuously receive service from a macro cell that is under the influence of intense interference from the femto cell, the MUE may measure the signal of a serving macro cell by using the ABS of the femto cell. As a result, in light of the MUE, the interference of the femto cell is reduced in the macro cell (i.e., the coverage of the femto cell is reduced).

Although FIG. 9 shows a case when the macro cell does not overlap with the ABS of the femto cell, this is merely exemplary, and, therefore, at least of portion of the macro cell and the AMS of the femto cell may overlap one another. However, based upon the fact that data scheduling for the MUE is realized in a subframe of the macro cell, which corresponds to the ABS of the femto cell, it is preferable that the macro cell and the ABS of the femto cell do not overall one another.

In this example, although a combined scenario of the Macro Cell-Pico Cell case and the Macro Cell-Femto Cell case is shown in the drawing, this is merely exemplary, and, therefore, the Macro Cell-Pico Cell and the Macro Cell-Femto Cell may be separately configured.

### Embodiment: The Usage of ABS During Cell Selection/Re-Selection

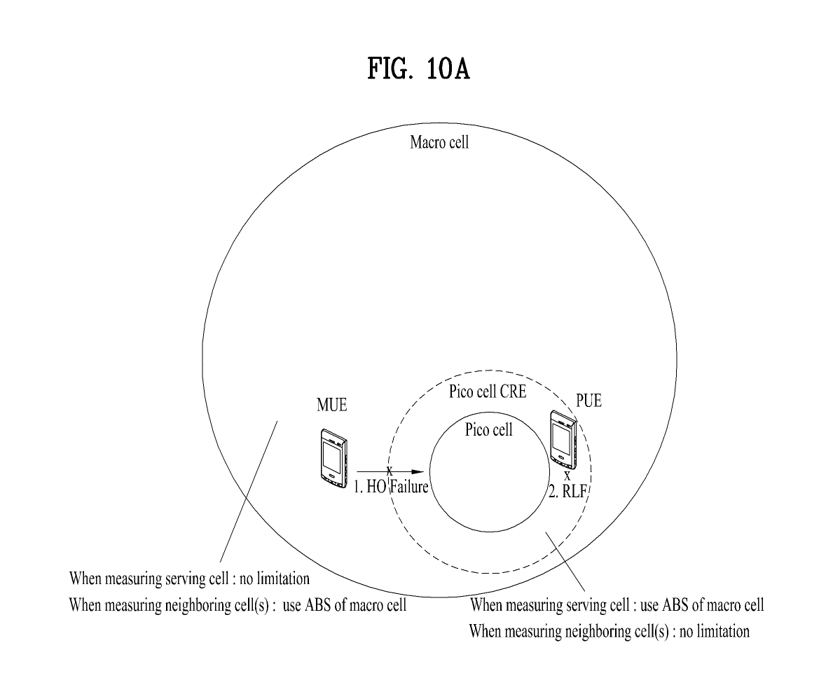

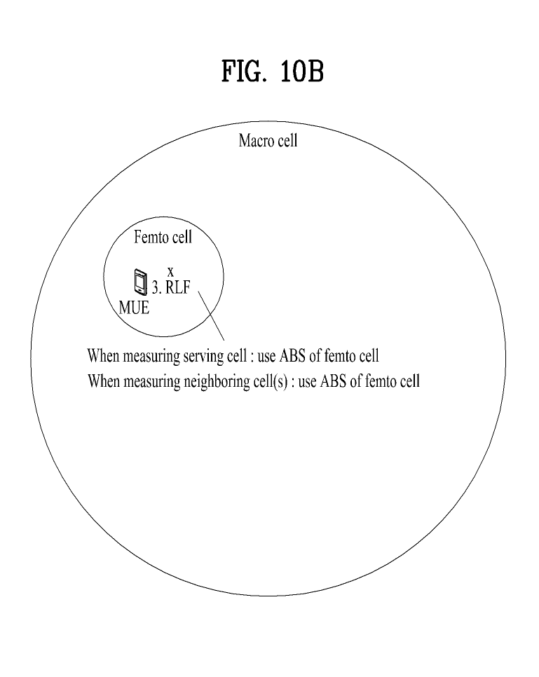

FIGS. 10A˜10B illustrate an exemplary case when a Handover (HO) failure or Radio Link Failure (RLF) occurs in the heterogeneous network. More specifically, FIG. 10A shows a case when an HO failure (Case 1) and an RLF (Case 2) occur in the Macro-Pico, and FIG. 10B shows a case when an RLF (Case 3) occurs in the Macro-Femto.

Referring to FIGS. 10A˜10B, more specifically, the following scenario may be realized.
Case 1: This corresponds to a case when a MUE, which measures the signal of a neighboring Pico cell by using the ABS of the macro cell, fails to complete a handover from the macro cell to a pico cell.
Case 2: This corresponds to a case when a PUE, which measures the signal of a serving pico cell by using the ABS of a macro cell, declares an RLF in the serving pico cell.
Case 3: This corresponds to a case when an MUE, which measures the signal of a serving macro cell by using the ABS of a femto cell, declares an RLF in the serving macro cell.

As described above, when an HO failure or RLF occurs, the UE performs cell selection and, then, initiates an RRC connection reestablishment procedure in the corresponding cell. Meanwhile, in the related art cell selection/re-selection procedure, which was described earlier with reference to FIG. 7, the user equipment does not use the ABS when measuring the signal of a neighboring cell. This is because the cell selection/re-selection procedure is basically performed when the user equipment is in an RRC idle mode, whereas the signal measurement using ABS is performed when the user equipment is in an RRC connection mode. However, when an RRC connection reestablishment procedure is required due to the HO failure or RLF, the user equipment exceptionally performs the cell selection/re-selection process in the RRC connection mode. Accordingly, before the RRC connection reestablishment procedure is completed, whether or not the UE should select a cell by using an ABS (pattern), which was previously set-up, becomes a problem.

Before the completion of the RRC connection reestablishment procedure, if the ABS is not used identically as the conventional cell selection/re-selection procedure, the following problems may occur.

For example, in order to move (or relocate) the MUE to a pico cell for reasons of load-distribution, it will be assumed that the MUE is set-up to use an ABS (pattern) of the macro cell when measuring the signal of a neighboring pico cell. When the MUE reports the measurement result of the pico cell using the ABS, for example, by transmitting an RRS connection reestablishment message having MCI, the macro cell may move (or relocate) the MUE to a pico cell. However, as shown in Case 1 of FIG. 10A, an HO failure may occur.

When an HO failure occurs, the UE performs cell selection for the RRC connection reestablishment. At this point, when it is assumed that the UE does not use the ABS (pattern) for the cell selection, the UE may select a cell once again and may return to the macro cell in accordingly. However, the selection of the macro cell may not be required to the UE by the network. Therefore, when the UE selects a macro cell, the macro cell may reestablish (or reconfigure) the ABS (pattern) information in order to move (or relocate) the UE back to the pico cell, and, as a result, the UE may attempt HO once again to the pico cell. Accordingly, as the UE remains in an HO region (or section) for a long period of time, HO to the pico cell, HO failure, and selection of the maco cell may be unnecessarily repeated.

In order to resolve the above-described problems, this example proposes a method of performing cell selection/re-selection by using an already-configured ABS, in case the user equipment performs cell selection/re-selection under a predetermined condition. More specifically, the user equipment may measure the signal of a neighboring cell by using the already-configured ABS and may perform cell selection/re-selection as described above with reference to FIG. 7. Herein, the predetermined condition includes that the user equipment perform cell selection/re-selection in the RRC connection mode. Additionally, the predetermined condition includes that the user equipment perform cell selection/re-selection for the RRC connection reestablishment. Furthermore, the predetermined condition includes that the user equipment perform cell selection/re-selection for reasons of HO failure or RLF.

For example, in case of an HO failure or RLF, the UE being in the RRC connection mode may perform cell selection/re-selection by using an ABS (pattern), which was previously configured (through dedicated signaling) before the RRC connection reestablishment. Accordingly, the likelihood of the user equipment selecting a cell having the ABS (pattern) configured therein becomes higher. Herein, the cell having the ABS (pattern) configured therein refers to a cell (e.g., pico cell), which is configured to use an ABS of a macro cell when measuring the corresponding cell. One cell may correspond to one ABS (pattern), or a plurality of cells may be configured to correspond to one ABS (pattern). Alternatively, all cells may correspond to one ABS (pattern). The correspondence between the ABS (pattern) and the cell may be signaled along with the ABS (pattern) allocation. In case the cell having the ABS configured therein correspond to a pico cell, the UE may select the pico cell more easily by using the ABS (pattern), and may perform RRC connection reestablishment in the pico cell. As described above, by using the ABS for cell selection, the repetition of unnecessary procedures may be avoided.

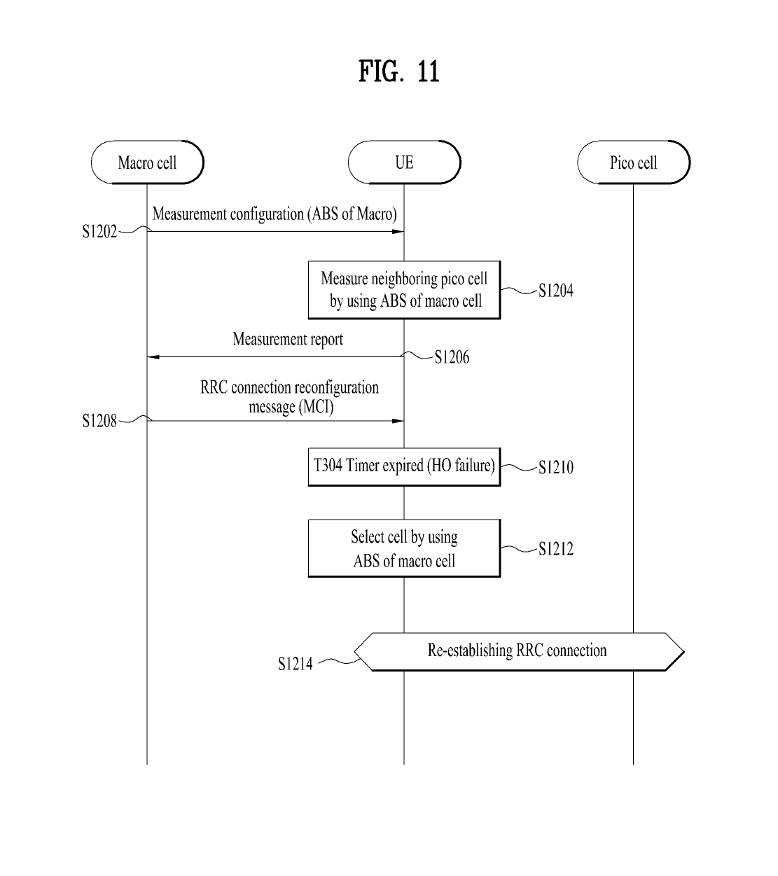

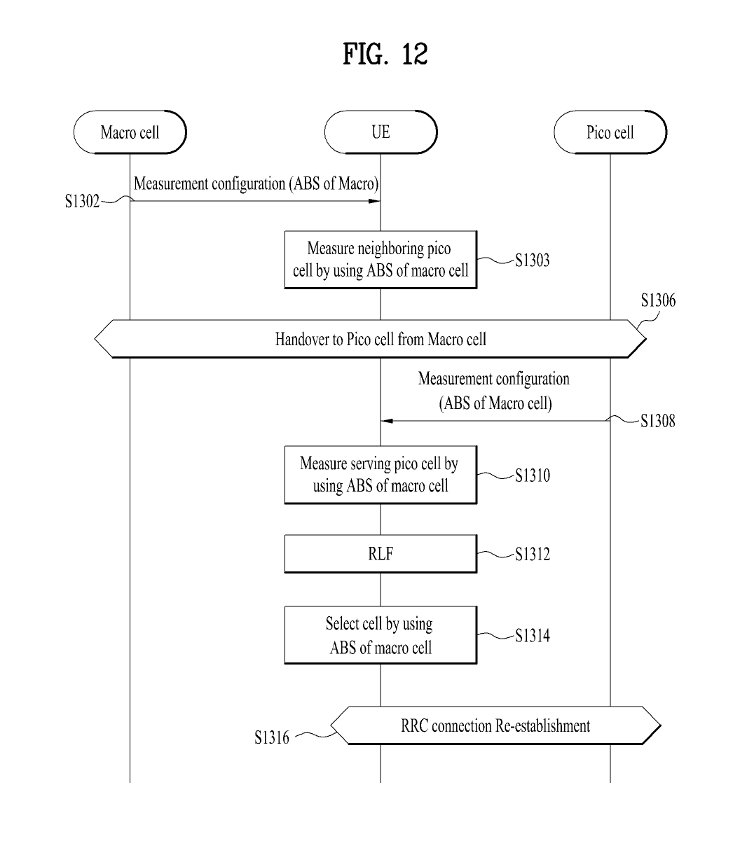

FIG. 11 illustrates exemplary procedure according to the exemplary embodiment of the present invention. This example shows an exemplary procedure of performing RRC connection reestablishment after an HO failure. Referring to FIG. 11, the procedure according to the example may be performed in accordance with the following order.

1. By transmitting measurement configuration having ABS allocation information (e.g., ABS pattern information) of the macro cell to the UE, the macro cell may set up the UE to measure the signal of a pico cell by using the ABS of the macro cell (S1202). The UE may store measurement configuration having the ABS allocation information of the macro cell. The measurement configuration may be transmitted through an RRC connection reestablishment message.

2. The UE measures the signal of a neighboring pico cell by using the ABS of the macro cell (S 1204).

3. In case the signal quality of the pico cell is good for performing handover, the UE reports the measurement result performed on the pico cell to the macro cell (S 1206).

4. The macro cell commands a handover to the UE (S1208). The handover command may be directed by the transmission of the RRC connection reestablishment message having the MCI (Mobility Control Information). If the RRC connection reestablishment message includes the ABS allocation information of the macro cell, the UE may replace the stored ABS allocation information of the macro cell with the ABS allocation information of the ABS allocation information included in the RRC connection reestablishment message. If the ABS allocation information is not included in the RRC connection reestablishment message, the UE may preserve the stored ABS allocation information of the macro cell even after the handover to the pico cell is completed.

In case of receiving the RRC connection reestablishment message having the MCI, the UE initiates an operation for the handover and operates a timer (e.g., T304 timer) in order to prevent the handover procedure from being excessively delayed.

5. If the handover to the pico cell is not completed before the expiration of the T304 timer (e.g., random access procedure failure), the UE may declare handover failure after the expiration of the T304 timer (S1210).

6. If the HO is failed, the UE performs cell selection for RRC connection reestablishment. At this point, as proposed in the description of the present invention, the UE performs the cell selection procedure by using the ABS information of the macro cell (S1212). During this procedure, the UE may use the stored ABS allocation information of the macro cell in order to measure the signal of a cell having the ABS configured therein (e.g., pico cell). However, in order to measure the signal of a cell that does not have any ABS configured therein (e.g., macro cell, femto cell, etc.), the UE does not use the stored ABS allocation information of the macro cell.

7. If the UE selects the pico cell, the UE transmits an RRC connection reestablishment message for the RRC connection reestablishment in the pico cell to the pico cell (S1214).

FIG. 12 illustrates another exemplary procedure according to the exemplary embodiment of the present invention. This example shows an exemplary procedure of performing RRC connection reestablishment after the occurrence of an RLF. Referring to FIG. 12, the procedure according to the example may be performed in accordance with the following order.

1. By transmitting measurement configuration having ABS allocation information (e.g., ABS pattern information) of the macro cell to the UE, the macro cell may set up the UE to measure the signal of a pico cell by using the ABS of the macro cell (S1302). The UE stores measurement configuration having the ABS allocation information of the macro cell. The measurement configuration may be transmitted through an RRC connection reestablishment message.

2. The UE measures the signal of a neighboring pico cell by using the ABS of the macro cell (S1304).

3. The UE moves from the macro cell to the pico cell through the handover (S1306).

4. By transmitting the ABS allocation information (e.g., ABS pattern information) of the macro cell, wherein the ABS allocation information has measurement configuration, the pico cell may set up the UE to measure the signal of the pico cell by using the ABS information of the macro cell (S1308). The UE may store the ABS allocation information of the macro cell having the measurement configuration. The measurement configuration may be transmitted through the RRC connection reestablishment message.

5. The UE measures the signal of a serving pico cell by using the most recent macro cell ABS, which is assigned (or given) by the macro cell or pico cell (S1310).

6. For a particular reason, the UE declares the RLF (radio link failure) from the pico cell (S1312).

7. If an RLF occurs, the UE performs cell selection for RRC connection reestablishment. At this point, as proposed in the description of the present invention, the UE performs the cell selection procedure by using the ABS information of the macro cell (S1314). During this procedure, the UE may use the stored ABS allocation information of the macro cell in order to measure the signal of a cell having the ABS configured therein (e.g., pico cell). However, in order to measure the signal of a cell that does not have any ABS configured therein (e.g., macro cell, femto cell, etc.), the UE does not use the stored ABS allocation information of the macro cell.

8. If the UE selects the pico cell, the UE transmits an RRC connection reestablishment message for the reestablishment in the pico cell to the pico cell (S1316).

Most particularly, in case the ABS is not used for the cell selection in Case 3 (FIG. 10B, Femto cell RLF), due to the intense interference from the femto cell, the UE may not be capable of finding a suitable cell (e.g., pico cell). Since the macro cell has determined a macro cell ABS and/or femto cell ABD to the UE in advance prior to the RLF, in the advent of the RLF, as proposed in the present invention, by performing cell selection/re-selection using the ABS, the MUE may be capable of easily finding the suitable cell (e.g., pico cell).

Therefore, in case the UE being in the RRC connection mode is using the ABS, which is set up (or determined) through dedicated signaling, and in case HO failure or RLF has occurred, the UE being in the RRC connection mode may perform cell selection by using the ABS of the cell having the ABS set up (or determined) therein, even after the RRC connection reestablishment.

In FIG. 11 and FIG. 12, in case the UE fails to perform RRC connection reestablishment (S1214, S1316), the UE goes into the RRC idle mode. In this case, the UE removes (or deletes) the stored macro ABS (pattern) configuration. Accordingly, in the idle mode, the UE cannot use the ABS for cell selection/re-selection. As another method, the UE may continue to preserve the stored macro ABS (pattern). In this case, the UE may use the ABS for cell selection/re-selection in the idle mode state up until the point the UE receives updated ABS allocation information through the system information or through dedicated signaling in the connection mode.

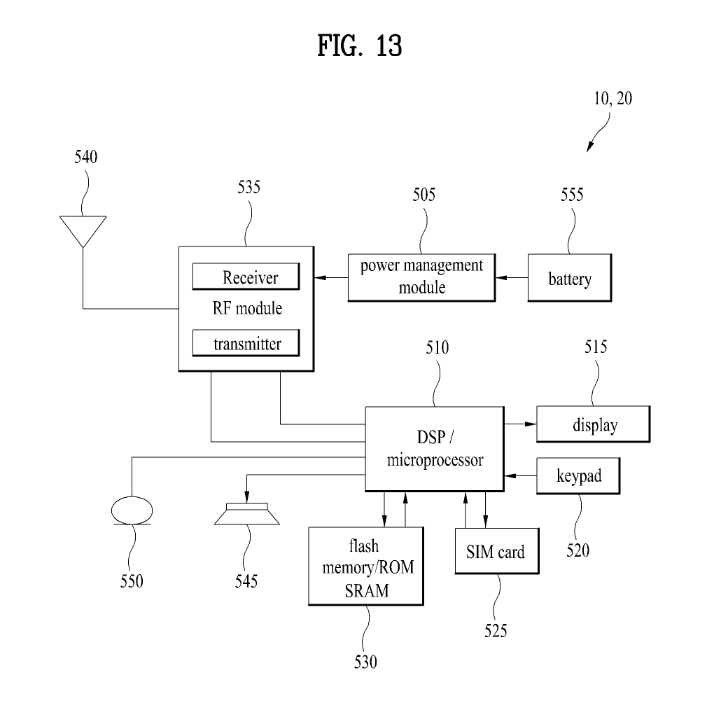

FIG. 13 illustrates an exemplary communication device (e.g., user equipment, base station) that is used in the exemplary communication system described in the present invention. For simplicity, although FIG. 13 is mostly focused on a mobile station (MS) or UE (10), by changing a portion of the configuration, FIG. 13 may also be used as a block view of the base station.

Referring to FIG. 13, the UE (10) includes a processor (or digital signal processor) (1410), an RF (Radio Frequency) module (1435), a power management module (1405), an antenna (1440), batteries (1455), a display (1415), a keypad (1420), a memory (1430), a SIM card (1425) (this may be optional), a speaker (1445), and a microphone (1450).

The user, for example, inputs direction information, such as a phone number, by pressing buttons of the keypad (1420) or voice-activated operation using the microphone (1450). The microprocessor (1410) receives and processes the direction information, so as to perform a suitable function, such as dialing the phone number. Operation data are extracted from the Subscriber Identity Module (SIM) card (1425) or memory module (1430), so as to perform the respective function. Additionally, the processor (1420) may display direction and operation information on the display (1415) for the reference and convenience of the user.

The processor (1410) provides the direction information to the RF module (1435), so as to initiate communication, such as, for example, transmitting a radio signal including vocal (or voice) telecommunication data. The RF module (1435) includes a receiver and a transmitter for respectively receiving and transmitting radio signals. The antenna (1441) facilitates the transmission and reception of the radio signals. When a radio signal is received, the RF module (1435) forwards and converts the signal to a baseband frequency for processing performed by the processor (1410). Thereafter, the processed signal is converted to audible or readable information (or information that can be heard or read) and then outputted, for example, through the speaker (1445). The processor (1410) includes necessary protocols and functions required for performing the diverse processes described in the description of the present invention.

The aforementioned embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

The embodiments of the present invention have been described based on the data transmission and reception between the base station and the user equipment. A specific operation which has been described as being performed by the base station may be performed by an upper node of the base station as the case may be. In other words, it will be apparent that various operations performed for communication with the user equipment in the network which includes a plurality of network nodes along with the base station can be performed by the base station or network nodes other than the base station. The base station may be replaced with terms such as a fixed station, Node B, eNode B (eNB), access point, and so on. Also, the terminal may be replaced with terms such as UE (User Equipment), MS (Mobile Station), MSS (Mobile Subscriber Station), and so on.

The embodiments according to the present invention can be implemented by various means, for example, hardware, firmware, software, or their combination. If the embodiment according to the present invention is implemented by hardware, the embodiment of the present invention can be implemented by one or more ASICs (application specific integrated circuits), DSPs (digital signal processors), DSPDs (digital signal processing devices), PLDs (programmable logic devices), FPGAs (field programmable gate arrays), processors, controllers, microcontrollers, microprocessors, etc.

If the embodiment according to the present invention is implemented by firmware or software, the embodiment of the present invention may be implemented by a type of a module, a procedure, or a function, which performs functions or operations described as above. A software code may be stored in a memory unit and then may be driven by a processor. The memory unit may be located inside or outside the processor to transmit and receive data to and from the processor through various means which are well known.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

### INDUSTRIAL APPLICABILITY

The present invention may be used in wireless communication devices, such as user equipments, relays, base stations, and so on.

What is claimed is:

1. A method for reconfiguring a connection at a User Equipment (UE) in a wireless communication system, the method comprising:
receiving information about a specific time region in a state that a connection with a network is configured;
detecting a connection failure or releasing the connection with the network; and
receiving, for a cell selection, signals of one and more cells through the specific time region, after the detection or the release.

2. The method according to claim 1, further comprising:
selecting a specific cell of the one and more cells; and
reconfiguring a connection with the specific cell.

3. The method according to claim 1, wherein the signals of the one and more cells are received by using previous information about the specific time region before updated information about the specific time region is received.

4. The method according to claim 3, wherein the updated information is received through system information or dedicated signaling for the UE.

5. A User Equipment (UE) configured to reset a connection in a wireless communication system, comprising:
a Radio Frequency (RF) unit; and
a processor,
wherein the processor is configured to receive information about a specific time region in a state that a connection with a network is configured, to detect a connection failure or release the connection with the network, and to receive, for a cell selection, signals of one and more cells through the specific time region 1, after the detection or the release.

6. The UE according to claim 5, wherein the processor is further configured to select a specific cell of the one and more cells, and to reconfigure a connection with the specific cell.

7. The UE according to claim 5, the signals of the one and more cells are received by using previous information about the specific time region before updated information about the specific time region is received.

8. The UE according to claim 7, wherein the updated information is received through system information or dedicated signaling for the UE.
